(19) United States
(12) Patent Application Publication
(10) Pub. No.: US 2002/0056949 A1
(43) Pub. Date: May 16, 2002

(54) Process for producing polymeric films having shape-memorizing properties

(76) Inventors: Takashi Sasaki, Tokyo (JP); Isao Ishigaki, Gunma-ken (JP); Kohichiro Kawate, Tokyo (JP)

Correspondence Address: BANNER & WITCOFF, 1001 G STREET N W, SUITE 1100, WASHINGTON, DC, 20001, US

(21) Appl. No.: 09/966,269

(22) Filed: Oct. 1, 2001

Related U.S. Application Data
(63) Continuation of application No. 08/544,408, filed on Oct. 10, 1995, now abandoned.
Application No. 08/544,408 is a continuation of application No. 07/484,610, filed on Feb. 26, 1990, now abandoned.

(30) Foreign Application Priority Data
Aug. 21, 1990 (JP) 219382/1990

(51) Int. Cl. C08F 2/46; B29C 35/08

(52) U.S. Cl. 264/496; 522/182; 522/173

(57) ABSTRACT

This invention relates to the production of trans- parent, shape-memorizing resin films by curing with radiation. The resin film composition comprising:

(a) an oligomer compound that has at least one acryloyl or methacryloyl group in the molecule and that has a glass transition temperature, Tg, of lower than 50° C. after polymerization; and

(b) a low-molecular weight compound that has in its molecule one reactive double bond capable of polymerization with the oligomer compound (a) and that has a glass transition temperature, Tg, higher than 90° C. after polymerization; or

(b′) a mixture of two or more low-molecular weight compounds that have in their molecule one reactive double bond capable of copolymerization with the oligomer compound (a) and that have a glass transition temperature, Tg, higher than 90° C. after polymerization.

### BACKGROUND OF THE INVENTION

This invention relates to the production of transparent films by means of radiation curing. The term “shape-memorizing effect” or simply “shape-memorizing properties” as used used herein means the thermoelastic behavior of a material that is plastic at room temperature to deform permanently under an external force exceeding the elastic limit but which is completely restored to the initial shape upon heating to a shape recovery temperature or above.

Heat-shrinkable films are known as high-molecular weight materials that have similar properties to shape-memorizing resins. However, heat-shrinkable films are not completely restored to the initial shape even if they are heated and, in addition, they do not have a clear shape recovery temperature since they shrink gradually with increasing temperature. Because of their thermal elasticity, shape-memorizing resins are currently used in machine parts, medical devices, articles for daily use and toys. Commercial shape-memorizing resins are described in Japanese Patent Public Disclosure Nos. 53528/1984, 293214/1986, 192440/1987 and 179955/1988.

Resins conventionally known to have the shape-memorizing effect include polynorbornane, a styrene-butadiene copolymer, polyurethane and polyisoprene. The use of these resins has been limited since they can only be given the initial shape by thermal molding or chemical crosslinking. Further, resins shaped by thermal molding are not suitable for use at elevated temperatures and polyisoprene which is shaped by chemical crosslinking has the disadvantage that the shape-recovery temperature cannot be effectively controlled.

### SUMMARY OF THE INVENTION

The present invention has been accomplished under these circumstances and has as an object providing a method in which a liquid resin composition that is readily polymerized by irradiation to form a shape-memorizing resin is either applied to a shaped part or placed between films to be given a specified shape and is subsequently cured by radiation to produce a cured film having the memory of the specified shape. The present inventors investigated the mechanical properties of films produced by curing with radiation and found the following two types of formulations that provided films having the shape-memorizing effect:

(1) a resin composition comprising:

a) an oligomer that has at least one acryloyl or methacryloyl group in the molecule and that has a glass transition temperature, Tg, of no higher than 50° C. after polymerization; and

b) a low-molecular weight compound that has in its molecule one reactive double bond capable of copolymerization with the oligomer a) and that has a glass transition temperature, Tg, of at least 90° C. after polymerization; or

b′) a mixture of two or more low-molecular weight compounds that have in their molecule one reactive double bond capable of copolymerization with the oligomer compound a) and that have a glass transition temperature, Tg, of at lest 90° C. after polymerization;

and

(2) a liquid resin composition comprising:

a) an oligomer compound that has at least one acryloyl or methacryloyl group in the molecule and that has a glass transition temperature, Tg, of no higher than 50° C. after polymerization; and

b) a simple urethane adduct of hydroxyethyl acrylate or hydroxyethyl methacrylate and diisocyanate compound;

said liquid resin optionally containing:

c) a low-molecular weight compound that has in its molecule at least one double bond capable of copolymerization with the oligomer compound a).

### DETAILED DESCRIPTION OF THE INVENTION

When the resin composition (1) or (2) is cured after being applied to a shaped part, a replica of the shaped part is obtained as the cured film. The cured film is removed from the shaped part and it can be deformed to any shape under an external force. The film remains deformed at room temperature but upon heating to the shape-recovery temperature or above, the film is restored to the initial shape.

The resin compositions can be applied to the shape part by any of the methods used to apply conventional solvent-type resins. Instead of being applied to shaped parts, the liquid resins may be coated onto or placed between various supports such as plastic films and paper.

The resin compositions may be cured by various methods such as heating in the presence of known radical generators or curing with ultraviolet radiation in the presence of photo-sensitizers. But in view of the objects of the present invention, the most suitable method is curing with an ionizing radiation which does not involve substantial heat generation, particularly with electron beams generated by means of an electron accelerator. The atmosphere for irradiation may be the air but more desirably, it is an inert gas. There is no particular limitation on the energy of electron beams to be applied but an acceleration voltage of ca. 150-500 keV is efficient from the view point of production rate.

Examples of the simple urethane adduct b) as a component of the resin composition (2) include a compound having two molecules of hydroxyethyl acrylate reacted to one molecule of isophorone diisocyanate (the compound is hereunder referred to as IA), a compound having two molecules of hydroxyethyl methacrylate reacted to one molecule of isophorone diisocyanate (the compound is hereunder referred to as IMA) and a compound having two molecules of hydroxyethyl acrylate reacted to one molecule of toluene diisocyanate (the compound is hereunder referred to as TA). It is known to combine compound IA with diesters of polycarboxylic acids and use the combinations as adhesive compositions but such use differs from the one contemplated by the present invention.

The following examples are provided for the purpose of further illustrating the present invention but are in no way to be taken as limiting.

### EXAMPLE 1

Urethane acrylate (UX 4101 of Nippon Kayaku Co., Ltd.), IA and cyclohexyl acrylate (CHA) were used as compounds a), b) and c), respectively, in preparing sample of the resin composition (2). UX 4101, CHA and IA were mixed in 40, 40 and 20 parts by weight, respectively. The resulting resin composition was applied onto a tin plate having a conical projection that was 3 cm in diameter and 0.5 cm in height. The composition was cured by irradiating on a conveyor to 50 kGy with electron beams (300 keV) generated from a transformer rectified electron accelerator in a nitrogen atmosphere. The cured film was removed from the tin plate. The projecting cone was collapsed and the film was folded to a smaller size. The film remained in the folded state at room temperature. When the film was dipped into hot water at 60° C., it was restored to the initial shape within 3 seconds. It was also found that the restored shape was identical to the initial shape within a precision of 1%.

### EXAMPLE 2

Various formulations of the resin composition (1) were prepared using urethane acrylate (UX 4101 of Nippon Kayaku Co., Ltd.) or urethane acrylate (UV 7700B of the Nippon Synthetic Chemical Industry Co., Ltd.) as oligomer compound a), and low-molecular weight compounds that were capable of copolymerizing with the oligomer compound a) (for their names, see Table 1).

Each of the compositions prepared from those formulations was placed between two PET films 50 μm thick and cured by irradiating from both sides to 50 kGy (per side) in the same manner mentioned in Example 1, whereupon smooth-surfaced films having thicknesses of ca. 300 μm were obtained.

These films were subjected to measurements of their tensile characteristics using Strograph Rl (Toyo Seiki Seisaku-sho, Ltd.) at a tension speed of 10 mm/min. The films were also subjected to a 180° bending test, in which the films were bent 180° under a pressure of 1 kg/cm² at room temperature. Films that broke in the test were rated x and those which did not break were rated o. The permanent deformability of the films at room temperature was evaluated by measuring the angle of the bend in the samples that were left to stand for 24 hours after the 180° bend test. Films with a bend angle greater than 90° were rated o, those having a bend angle of 90° and smaller were rated Δ, and those in which the fold disappeared were rated x. The films that had been subjected to the 180° bend test were set in an oven and the temperature was raised stepwisely by 50° C. The temperature at which the fold disappeared was defined as the “shape recovery temperature”.

The results of various tests and measurements are shown in Tables 2 and 3.

TABLE 1
Monomers Used in Example 2
Monofunctional Monomer:

| | |
|---|---|
| 2-EHA | 2-Ethylhexyl acrylate |
| IOA | Isooctyl acrylate |
| 2-MTA | 2-Methoxyethyl acrylate |
| EA | Ethyl acrylate |
| MA | Methyl acrylate |
| CHA | Cyclohexyl acrylate |
| tBA | t-Butyl acrylate |
| IBA | Isobornyl acrylate |
| AA | Acrylic acid |
| DPA | Dicyclopentanyl acrylate |
| NVP | N-Vinylpyrrolidone |

Polyfunctional Monomer:

| | |
|---|---|
| HDDA | 1,6-Hexanediol diacrylate |
| NGTD | Neopenthylglycolated trimethylolpropane |
| | diacrylate |
| EBAD | Ethoxylated bisphenol A diacrylate |
| PNGD | Propoxylated neopentyl glycol diacrylate |
| ETPTA | Ethoxylated trimethylolpropane triacrylate |
| TMPTA | Trimethylolpropane triacrylate |

TABLE 2
Resin Formulations Using Urethane Acrylate UX 4101 and
the Mechanical Properties of Films Cured with Electron Beams

| | | Tg of | Tensile | | | 180° | Permanent | Shape recovery |
|---|---|---|---|---|---|---|---|---|
| | | poly X | strength | Elongation | Young's | Bend | deforma- | temperature |
| X | UX 4101/X | (° C.) | (kg/cm²) | (%) | modulus | test | tion | (° C.) |
| IOA | 60/40 | −65 | 20 | 70 | 30 | ∘ | X | — |
| 2-EHA | 60/40 | −50 | 20 | 90 | 30 | ∘ | X | — |
| 2-MTA | 60/40 | −50 | 30 | 100 | 30 | ∘ | X | — |
| EA | 60/40 | −23 | 40 | 160 | 30 | ∘ | X | — |
| MA | 60/40 | 3 | 200 | 250 | 40 | ∘ | X | — |
| CHA | 60/40 | 15 | 300 | 240 | 70 | ∘ | X | — |
| tBA | 60/40 | 41 | 380 | 230 | 300 | ∘ | X | — |
| IBA | 60/40 | 94 | 410 | 160 | 5700 | ∘ | Δ | 60 |
| AA | 60/40 | 106 | 680 | 150 | 12400 | ∘ | ∘ | 95 |
| DPA | 60/40 | 120 | 400 | 160 | 4600 | ∘ | Δ | 50 |
| NVP | 60/40 | 175 | 560 | 110 | 12000 | ∘ | ∘ | 80 |
| NGTD | 70/30 | 75 | 320 | 30 | 9100 | X | X | — |
| HDDA | 70/30 | | 180 | 30 | 1500 | X | X | — |
| EBAD | 60/40 | | 240 | 40 | 5100 | X | X | — |

TABLE 3
Resin Formulations Using Urethane Acrylate UV 7700B and
the Mechanical Properties of Films Cured with Electron Beams

| | | Tg of | Tensile | | | 180° | Permanent | Shape recovery |
|---|---|---|---|---|---|---|---|---|
| | | poly X | strength | Elongation | Young's | Bend | deforma- | temperature |
| X | UV 7700B/X | (° C.) | (kg/cm²) | (%) | modulus | test | tion | (° C.) |
| 2-EHA | 60/40 | −50 | 20 | 40 | 20 | X | X | — |
| 2-MTA | 60/40 | −50 | 30 | 40 | 20 | X | X | — |
| EA | 60/40 | −23 | 60 | 80 | 20 | o | X | — |
| MA | 60/40 | 3 | 130 | 130 | 110 | o | X | — |
| tBA | 60/40 | 41 | 320 | 110 | 3800 | o | X | — |
| IBA | 60/40 | 94 | 300 | 60 | 8500 | o | Δ | 45 |
| DPA | 60/40 | 120 | 310 | 50 | 12400 | o | o | 45 |
| HDDA | 95/5 | | 190 | 60 | 300 | o | X | — |
| HDDA | 90/10 | | 170 | 40 | 970 | X | X | — |
| HDDA | 75/25 | | 200 | 20 | 2800 | X | X | — |
| PNGD | 80/20 | | 180 | 50 | 320 | X | X | — |
| ETPTA | 80/20 | | 220 | 30 | 2300 | X | X | — |

As is clear from Tables 2 and 3, monomer b) has to be a monofunctional low-molecular weight compound having a glass transition temperature, Tg, of at least 90° C. after polymerization. If monofunctional monomers having Tg of lower than 90° C. are used, the resulting cured films have low Young's moduli and cannot be deformed permanently. If polyfunctional monomers are used, the Young's modulus increases and the cured films become brittle. The tensile strength of cured films is also related closely to Tg after polymerization and it was apparent that satisfactory tensile strength could not be attained when monofunctional monomers of low Tg were used.

### EXAMPLE 3

Samples of the resin composition (2) were prepared as in Example 2 using urethane acrylate UX 4101 or Uw 7700B as compound a), IA, IMA or TA as compound b), and CRA, tBA, IBA or DPA as compound c). The results of various tests and measurements conducted on the samples are shown in Table 4.

TABLE 4
Resin Formulations and the Mechanical Properties of
Films Cured with Electron Beams

| | | | | | | | | |
|---|---|---|---|---|---|---|---|---|
| | | | Tensile | | | 180° | Permanent | Shape recovery |
| | | | strength | Elongation | Young's | Bend | deforma- | temperature |
| b) | c) | a)/b)/c) | (kg/cm²) | (%) | modulus | test | tion | (° C.) |

a) = UV 770GB

| | | | | | | | | |
|---|---|---|---|---|---|---|---|---|
| IA | − | 95/ 5/0 | 180 | 60 | 760 | ∘ | X | — |
| IA | − | 90/10/0 | 240 | 60 | 1700 | ∘ | X | — |
| IA | − | 75/25/0 | 360 | 50 | 5100 | ∘ | Δ | 45 |
| IA | − | 50/50/0 | 490 | 5 | 12000 | X | X | — |

a) = UX 4101

| | | | | | | | | |
|---|---|---|---|---|---|---|---|---|
| IA | CHA | 40/20/40 | 310 | 40 | 15000 | ∘ | ∘ | 55 |
| IA | tBA | 50/10/40 | 380 | 110 | 9900 | ∘ | ∘ | 45 |
| IA | IBA | 50/10/40 | 380 | 60 | 10000 | ∘ | ∘ | 65 |
| IA | DPA | 50/10/40 | 380 | 70 | 9500 | ∘ | ∘ | 60 |
| IMA | CHA | 40/20/40 | 360 | 80 | 6400 | ∘ | ∘ | 70 |
| TA | CHA | 40/20/40 | 280 | 50 | 6900 | ∘ | ∘ | 55 |

As Table 4 shows, the addition of compound b) to urethane acrylate UV 7700B contributed higher Young's modulus and tensile strength but the decrease in elongation was not substantial and the resulting cured films had the desired shape-memorizing effect. The unique effect of compound b) will become apparent by comparison with the UV 7700B/HDDA system shown in Table 3. The addition of HDDA to UV 7700B caused considerable drop in elongation and the cured films became brittle. Many varieties of shape-memorizing films can be produced by adding compound b) and monofunctional monomers to UX 4101.

What is claimed is:

1. A process for producing a cured film having the memory of a specified shape, which process comprises shaping a resin composition by either applying it onto a shaped part or placing it between films, curing said resin composition with electron beams, and removing the cured composition from the shaped part or films, said resin composition comprising:
(a) an oligomer compound that has at least one acryloyl or methacryloyl group in the molecule and that has a glass transition temperature, Tg, of lower than 50° C. after polymerization; and
(b) a low-molecular weight compound that has in its molecule one reactive double bond capable of polymerization with the oligomer compound (a) and that has a glass transition temperature, Tg, higher than at least 90° C. after polymerization; or
(b′) a mixture of two or more low-molecular weight compounds that have in their molecule one reactive double bond capable of copolymerization with the oligomer compound (a) and that have a glass transition temperature, Tg, higher than 90° C. after polymerization.

2. A process for producing a cured film having the memory of a specified shape, which process comprises shaping a resin composition by either applying it onto a shaped part or placing it between films, curing said resin composition with electron beams, and removing the cured composition from the shaped part or films, said resin composition comprising:
(a) an oligomer compound that has at least one acryloyl or methacryloyl group in the molecule and that has a glass transition temperature, Tg, lower than 50° C. after polymerization;
(b) a simple urethane adduct of hydroxyethyl acrylate or hydroxyethyl methacrylate and a diisocyanate; and
(c) an optional low-molecular weight compound that has in its molecule at least one double bond capable of copolymerization with the oligomer compound (a).
